(19) United States
(12) Patent Application Publication
(10) Pub. No.: US 2018/0036883 A1
(43) Pub. Date: Feb. 8, 2018

(54) SIMULATION APPARATUS, ROBOT CONTROL APPARATUS AND ROBOT

(71) Applicant: Seiko Epson Corporation, Tokyo (JP)

(72) Inventors: Masanobu NISHITANI, Suwa (JP); Tsutomu HAGIHARA, Hara (JP)

(21) Appl. No.: 15/663,954

(22) Filed: Jul. 31, 2017

(30) Foreign Application Priority Data
Aug. 4, 2016 (JP) 2016-153944

(51) Int. Cl. B25J 9/16

(52) U.S. Cl. CPC B25J 9/1671

(57) ABSTRACT

A simulation apparatus that performs an operation of a virtual robot as a virtualization of a robot, includes a processor that is configured to specify a plurality of line segments of an outer shape of a virtual object as a virtualization of a work object of the robot, wherein data of the virtual object is converted from a first format into a second format having a data volume compressed to one tenth or less of that of the first format, and the processor is configured to operate the virtual robot based on selected line segments of the plurality of line segments.

### BACKGROUND

### 1. Technical Field

The present invention relates to a simulation apparatus, robot control apparatus, and robot.

### 2. Related Art

In related art, a technology without using a real robot (real machine) of simulating work or the like with the real machine using a virtual robot within a virtual space is known. In an apparatus for the simulation, in addition to the virtual robot, a virtual peripheral that loads three-dimensional CAD (computer aided design) data of a peripheral or the like as a virtualization of a real peripheral is provided within the virtual space. Thereby, offline teaching of a robot, layout check of a peripheral, collision check between the peripheral and the robot, etc. are verified.

An example of the simulation apparatus is disclosed in Patent Document 1 (JP-A-2003-150220). In the simulation apparatus according to Patent Document 1, offline teaching of a robot on a work may be performed using a three-dimensional model of the work (object) loaded from another CAD apparatus than the simulation apparatus and a three-dimensional model of the robot recorded in the simulation apparatus in advance.

However, when the configuration of the peripheral, the work, or the like is complex, the volume of the three-dimensional CAD data may reach e.g. several gigabytes. Loading of the data in the simulation apparatus takes time and the operation simulation of a simulation after loading is heavy. Further, some low-specification PCs (personal computers) have failures in response and controllability. As measures for the failures, for example, a method of deleting the CAD data by a mechanical CAD for lightening is considered. However, in this method, time is taken for the work and load on the worker is heavy. Accordingly, there is a problem that work efficiency by the simulation apparatus is lower.

### SUMMARY

An advantage of some aspects of the invention is to solve the problems described above, and the invention can be implemented as the following configurations.

A simulation apparatus according to an aspect of the invention is a simulation apparatus that performs an operation of a virtual robot as a virtualization of a robot, including a processing unit that specifies a plurality of line segments of an outer shape of a virtual object as a virtualization of a work object of the robot, wherein data of the virtual object is converted from a first format into a second format having a data volume compressed to one tenth or less of that of the first format, and the processing unit operates the virtual robot based on selected line segments of the plurality of line segments.

According to the simulation apparatus of the aspect of the invention, the times to read in and read out the data of the virtual object or the like may be significantly reduced. Further, the work of manually deleting unnecessary data may be saved. Teaching points and a set route of the virtual robot may be generated based on the information of the line segments, and the generation work may be performed relatively easily. Furthermore, an operation program of the virtual robot may be created using the teaching points, and thereby, the man-hours for the description work of programs in combination of many teaching points and the operation commands of the virtual robot may be significantly reduced. Thus, the work efficiency by the simulation apparatus according to the aspect of the invention may be improved.

In the simulation apparatus according to the aspect of the invention, it is preferable that the second format has one hundredth data volume or less of that of the first format.

With this configuration, the times to read in and read out the data of the virtual object or the like may be significantly reduced, and thus, the work efficiency by the simulation apparatus may be further improved.

In the simulation apparatus according to the aspect of the invention, it is preferable that the second format is an XVL format.

Because of the XVL (eXtensible Virtual world description Language) format, the times to read in and read out the data of the virtual object or the like may be significantly reduced.

In the simulation apparatus according to the aspect of the invention, it is preferable that the processing unit has a function of setting a position and an attitude of the virtual robot at teaching point on the selected respective line segments and a function of outputting signals for indicating the set position and attitude of the virtual robot.

With this configuration, the worker may visually recognize the position and attitude of the virtual robot (the position and attitude of the distal end of a robot arm) at the teaching points via a display unit, and whether with or without interferences between the virtual robot and peripherals or the like during work may be easily considered.

In the simulation apparatus according to the aspect of the invention, it is preferable that the setting of the attitude of the virtual robot at the teaching point can be changed.

With this configuration, the optimal attitude of the virtual robot during work may be set according to whether with or without interferences between the virtual robot and peripherals or the like.

In the simulation apparatus according to the aspect of the invention, it is preferable that the setting of the position of the virtual robot at the teaching point can be changed.

With this configuration, the optimal positions of the virtual robot at the teaching points during work may be set according to details of work.

In the simulation apparatus according to the aspect of the invention, it is preferable that a set route of an operation of the virtual robot based on the selected line segments can be generated and a position of the generated set route can be changed.

With this configuration, the optimal set routes may be generated according to details of work.

In the simulation apparatus according to the aspect of the invention, it is preferable that a set route of an operation of the virtual robot based on the selected line segments can be generated and at least one of contraction and expansion of the generated set route can be performed.

With this configuration, the optimal set routes may be generated according to details of work.

In the simulation apparatus according to the aspect of the invention, it is preferable that, when the set route contains an arc, at least one of contraction and expansion of the set route can be performed by changing a radius of the arc without changing a center of the arc.

With this configuration, the set route containing the arc shape (curve) may be easily set and changed.

A robot control apparatus according to an aspect of the invention controls a robot based on a simulation result by the simulation apparatus according to the aspect of the invention.

With this configuration, the robot control apparatus that may perform more proper control of the robot may be provided.

A robot according to an aspect of the invention is controlled by the robot control apparatus according to the aspect of the invention.

With this configuration, the robot that operates more properly may be provided.

### BRIEF DESCRIPTION OF THE DRAWINGS

The invention will be described with reference to the accompanying drawings, wherein like numbers reference like elements.

FIG. 1 shows a robot according to an embodiment of the invention.

FIG. 2 is a system configuration diagram of a robot control apparatus and the robot shown in FIG. 1.

FIG. 3 is a system configuration diagram of a simulation apparatus according to an embodiment of the invention.

FIG. 4 shows an example of windows displayed on a screen of a display unit.

FIG. 5 is a flowchart showing a flow of setting of virtual offline teaching.

FIG. 6 is a diagram for explanation of a virtual object.

FIG. 7 shows a window used for storing line segments.

FIG. 8 shows a window used for storing line segments.

FIG. 9 is a diagram for explanation of correction of a set route.

FIG. 10 shows a window of a point file.

FIG. 11 shows a window used for correction of points.

FIG. 12 shows a window used for proceeding with work while checking a position and an attitude of a tool and a teaching point.

FIG. 13 shows an example of display of a coordinate systems of a virtual applicator at teaching points.

FIG. 14 shows a window used for execution of a robot operation program.

### DESCRIPTION OF EXEMPLARY EMBODIMENTS

As below, a simulation apparatus, a robot control apparatus, and a robot according to the invention will be explained in detail with reference to the embodiments shown in the accompanying drawings.

### 1. Robot System

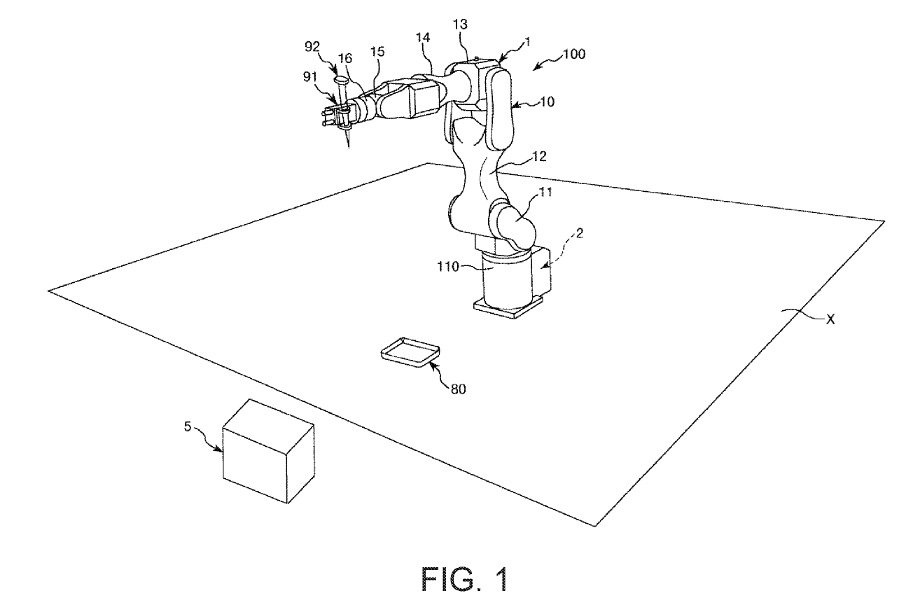

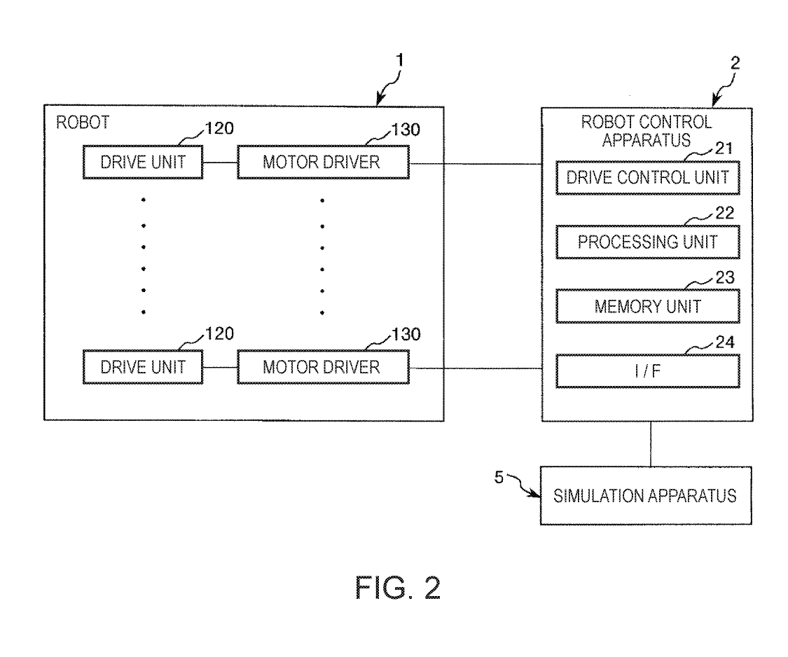

FIG. 1 shows a robot according to an embodiment of the invention. FIG. 2 is a system configuration diagram of a robot control apparatus and the robot shown in FIG. 1. Note that, hereinafter, for convenience of explanation, the downside (base 110 side) in FIG. 1 is referred to a “proximal end” and the opposite side is referred to as “distal end”.

A robot system 100 shown in FIG. 1 has a robot 1 and a robot control apparatus 2 as an example of the robot control apparatus according to the invention. The operation of the robot 1 is controlled by the robot control apparatus 2.

### Robot

The robot 1 is a six-axis vertical articulated robot, and has a base 110 and a robot arm 10 (manipulator) connected to the base 110. Further, a hand 91 (tool) is attached to the distal end of the robot arm 10. As shown in FIG. 2, the robot 1 includes a plurality of drive units 120 and a plurality of motor drivers 130 that generate power for driving the robot arm 10 shown in FIG. 1.

The base 110 shown in FIG. 1 is a part to which the robot 1 is attached to a predetermined location within a work area X in which the robot performs work. Further, in the embodiment, the robot control apparatus 2 is built in the base 110. Note that part or all of the robot control apparatus 2 may be built in the base 110, or the control apparatus may be separately provided from the robot 1.

The robot arm 10 has a first arm 11 (arm), a second arm 12 (arm), a third arm 13 (arm), a fourth arm 14 (arm), a fifth arm 15 (arm), and a sixth arm 16 (arm). The first arm 11 is connected to the base 110. The first arm 11, second arm 12, third arm 13, fourth arm 14, fifth arm 15, and sixth arm 16 are sequentially coupled from the proximal end side toward the distal end side. A hand 91 is attached to the distal end of the sixth arm 16. Further, in the embodiment, an applicator (attachment member) for application of an adhesive is attached to the hand 91.

The first arm 11 has a rotation shaft member (not shown) coupled to the base 110 and is rotatable with respect to the base 110 about a center axis of the rotation shaft member as a rotation center. The second arm 12 has a rotation shaft member (not shown) coupled to the first arm 11 and is rotatable with respect to the first arm 11 about a center axis of the rotation shaft member as a rotation center. The third arm 13 has a rotation shaft member (not shown) coupled to the second arm 12 and is rotatable with respect to the second arm 12 about a center axis of the rotation shaft member as a rotation center. The fourth arm 14 has a rotation shaft member (not shown) coupled to the third arm 13 and is rotatable with respect to the third arm 13 about a center axis of the rotation shaft member as a rotation center. The fifth arm 15 has a rotation shaft member (not shown) coupled to the fourth arm 14 and is rotatable with respect to the fourth arm 14 about a center axis of the rotation shaft member as a rotation center. The sixth arm 16 has a rotation shaft member (not shown) coupled to the fifth arm 15 and is rotatable with respect to the fifth arm 15 about a center axis of the rotation shaft member as a rotation center.

The plurality of drive units 120 having motors such as servo motors (not shown) and reducers (not shown) are respectively provided in the arms 11 to 16. That is, as shown in FIG. 2, the robot 1 has the drive units 120 in the number corresponding to the respective arms 11 to 16 (six in the embodiment). Further, the respective arms 11 to 16 are controlled by the robot control apparatus 2 via the plurality of (six in the embodiment) motor drivers 130 electrically connected to the respectively corresponding drive units 120.

In the respective drive units 120, e.g. angle sensors (not shown) such as encoders or rotary encoders are provided. Thereby, the rotation angles of the rotation shafts of the motors or the reducers of the respective drive units 120 may be detected.

### Robot Control Apparatus

The robot control apparatus 2 may include a personal computer (PC) having e.g. a CPU (Central Processing Unit), RAM (Random Access Memory), ROM (Read Only Memory), etc. or the like.

As shown in FIG. 2, the robot control apparatus 2 has a drive control unit 21, a processing unit 22, a memory unit 23, and an I/F 24 (interface). The drive control unit 21 and the processing unit 22 are formed by a CPU, and the drive control unit 21 has a function of controlling driving of the plurality of drive units 120 and the processing unit 22 has a function of performing various calculations etc. based on various signals. The memory unit 23 includes a RAM and ROM and has a function of storing or recording various kinds of information such as robot programs for controlling the driving of the drive units 120 (operation of the robot 1) and signals. The I/F 24 includes a hardware interface and a software interface.

Further, the robot control apparatus 2 may have devices having other configurations than the above described configurations as long as the apparatus has the above described functions. For example, the apparatus may have an external memory device such as a HDD (Hard Disk Drive), a display unit having a monitor such as a display, and an input unit for a worker to give instructions to the PC (e.g. a mouse, keyboard, or the like) etc.

The robot control apparatus 2 controls the robot 1 based on a simulation result by a simulation apparatus 5 as an example of the simulation apparatus according to the invention, which will be described later. For example, the apparatus may obtain the simulation result by the simulation apparatus 5 via the I/F 24 or an external memory device and make modifications of the robot program stored in the memory unit 23 or the like by the processing unit 22. Or, the robot control apparatus 2 may obtain a robot program created or modified based on the simulation result. As described above, the robot control apparatus 2 uses the result by the simulation apparatus 5, and thereby, may perform more proper control of the robot 1.

Note that the robot control apparatus 2 and the simulation apparatus 5 may be connected (in wired or wireless connection) or not.

The above described robot 1 is controlled by the robot control apparatus 2 as the example of the robot control apparatus according to the invention. Accordingly, the robot 1 that performs the more proper work may be provided.

The robot system 100 having the above described configuration is used for work of grasping and carrying an object 80 including an electronic component and electronic apparatus, application of an adhesive to the object 80, etc.

### 2. Simulation Apparatus

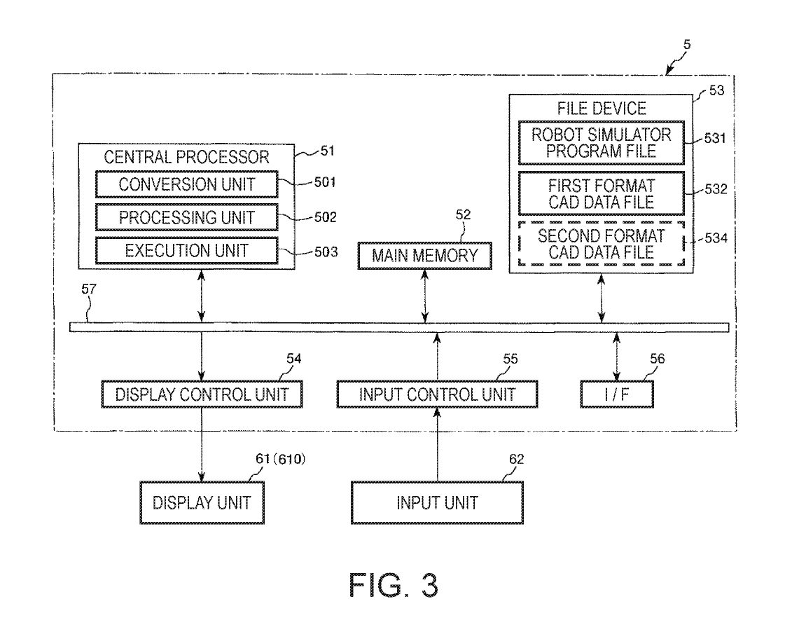

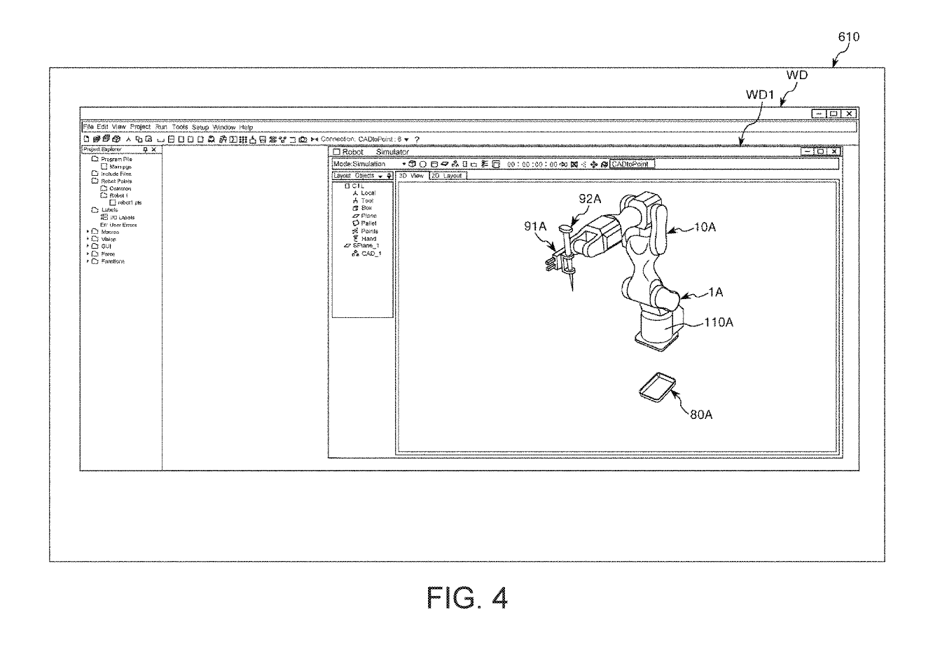

FIG. 3 is a system configuration diagram of the simulation apparatus according to an embodiment of the invention. FIG. 4 shows an example of windows displayed on a screen of a display unit.

The simulation apparatus 5 shown in FIG. 3 performs an operation of a virtual robot 1A, and thereby, performs a simulation of an operation of the robot 1 as a real machine.

The simulation apparatus 5 may include a personal computer (PC) having e.g. a CPU (Central Processing Unit), RAM (Random Access Memory), ROM (Read Only Memory), HDD (Hard Disk Drive), etc. or the like. As shown in FIG. 1, it is preferable that the simulation apparatus 5 is set outside of the work area X.

As shown in FIG. 3, the simulation apparatus 5 has a central processor 51 including a CPU, and a main memory 52, a file device 53, a display control unit 54, an input control unit 55, and an I/F 56 (interface) connected to one another by a bus 57 with the central processor 51 at the center.

Further, a display unit 61 (image display apparatus) including a monitor (not shown) such as a display having a screen 610 (see FIG. 4), an input unit 62 (input device) such as a mouse or keyboard are respectively connected (including wireless communications) to the simulation apparatus 5.

Note that, in the embodiment, the display unit 61 and the input unit 62 are explained as not belonging to the simulation apparatus 5, however, the simulation apparatus 5 may have the units.

For example, the central processor 51 performs various kinds of processing according to various kinds of data and programs stored or recorded in the main memory 52 and the file device 53. The central processor 51 has a conversion unit 501, a processing unit 502, and an execution unit 503. The conversion unit 501 performs conversion of a file format. The processing unit 502 performs processing of various kinds of calculations, settings, etc. The execution unit 503 performs execution of various programs based on the processing by the processing unit 502.

The I/F 56 includes a hardware interface and a software interface.

The main memory 52 includes a RAM, has a function of storing various kinds of data, programs, etc., and serves as a work area of the central processor 51.

The file device 53 includes a ROM, HDD, etc., and has a function of temporarily storing various kinds of data, programs, etc. In the file device 53, a robot simulator program file 531, a first format CAD data file 532 (intermediate file), a second format CAD data file 534, etc. may be recorded.

The robot simulator program file 531 is the same program as the robot program of the robot control apparatus 2 for controlling the operation of the robot 1.

The second format CAD data file 534 includes a three-dimensional model of a virtual object 80A. The second format CAD data file 534 is a file formed by lightening of the first format CAD data file 532 (intermediate file). The first format CAD data file 532 is a file formed by conversion of a CAD data file generated by another CAD apparatus (not shown) than the simulation apparatus 5 for the purpose of compatibility or the like.

In the embodiment, the conversion of the first format CAD data file 532 is performed in the CAD apparatus, and the first format CAD data file 532 is converted into the second format CAD data file 534 with the less volume of data than that of the first format CAD data file 532 in the simulation apparatus 5.

The data volume of the above described second format is equal to or less than one tenth of the data volume of the first format, and preferably equal to or less than one hundredth thereof. Thereby, the times to read in and read out data may be significantly reduced, and thus, work efficiency by the simulation apparatus 5 may be further improved.

Specifically, the format of the CAD data file generated using the above described CAD apparatus includes e.g. a SOLDWORKS format. The above described first format includes an IGES format, Step format, VRML format, and DXF format. The above described second format includes an XVL (eXtensible Virtual world description Language) format. The second format is the XVL format, and thereby, the times to read in and read out data may be significantly reduced. Particularly, the format is effective for reading in data of a structure having a complex configuration (e.g. a peripheral having a complex configuration).

The various files including the robot simulator program file 531 are stored in e.g. a recording medium (not shown) such as a CD-ROM, and provided from the recording medium. Note that the various files including the robot simulator program file 531 may not necessarily be stored in the recording medium, but provided via a network or the like.

The display control unit 54 includes e.g. a graphic controller and is connected to the display unit 61. The display control unit 54 has a function of allowing the screen 610 of the display unit 61 to display various kinds of operation windows etc. For example, as shown in FIG. 4, the display control unit 54 allows the screen 610 to display images of the virtual robot 1A and the virtual object 80A corresponding to (as virtualizations of) the robot 1 as the real machine and the object 80.

Further, the input control unit 55 has a function of receiving input from the input unit 62 having the mouse, keyboard, or the like. Therefore, the worker may give instructions for various kinds of processing etc. to the simulation apparatus 5 using the input unit 62.

The simulation apparatus 5 is used, and thereby, check and verification of the operation of the virtual robot LA as the virtualization of the robot 1 may be performed on the screen 610 (in the virtual space). Further, predetermined work may be taught to the virtual robot 1A and the taught work may be verified by the simulation apparatus 5. Furthermore, offline teaching of the robot 1 as the real machine may be performed based on the teaching for the virtual robot 1A. Accordingly, without using the robot 1 as the real machine, the cycle time of the robot 1 (operation time of the apparatus) in the offline teaching of the real robot 1 and the real work or the like may be considered.

### Teaching by Simulation Apparatus

Next, the teaching of the virtual robot 1A by the above described simulation apparatus 5, i.e., virtual offline teaching will be explained.

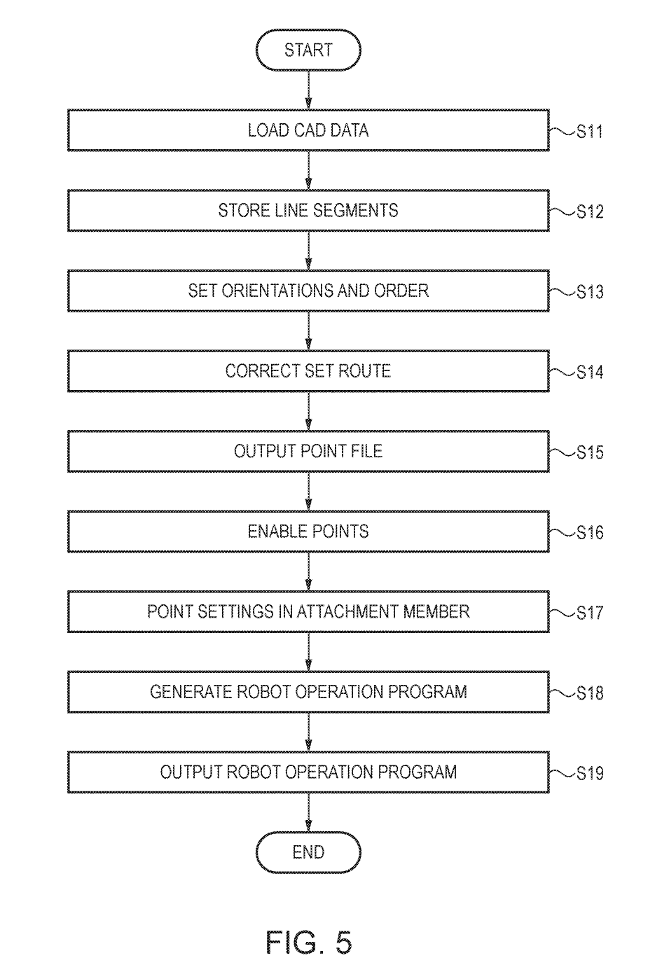

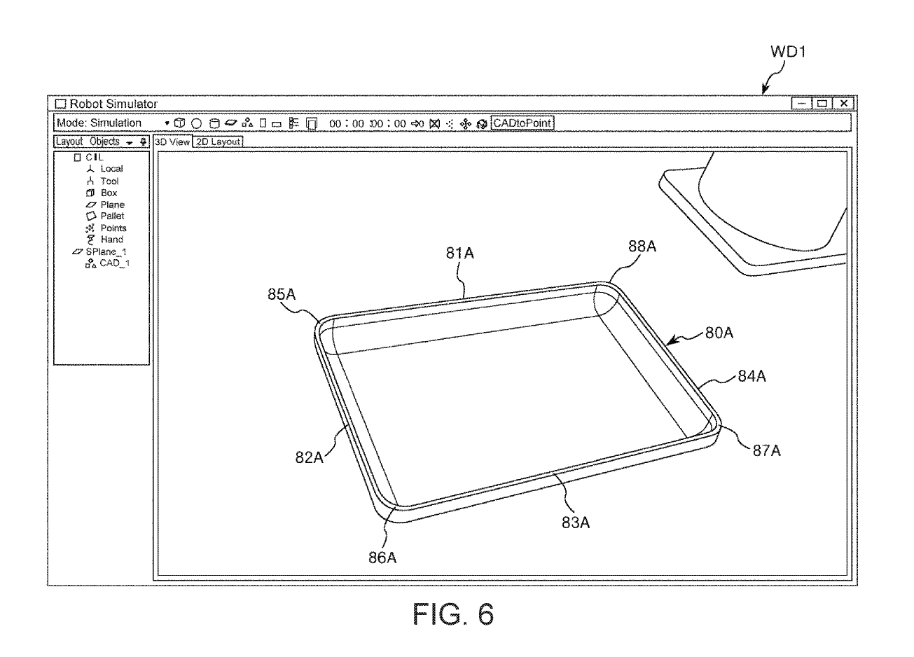

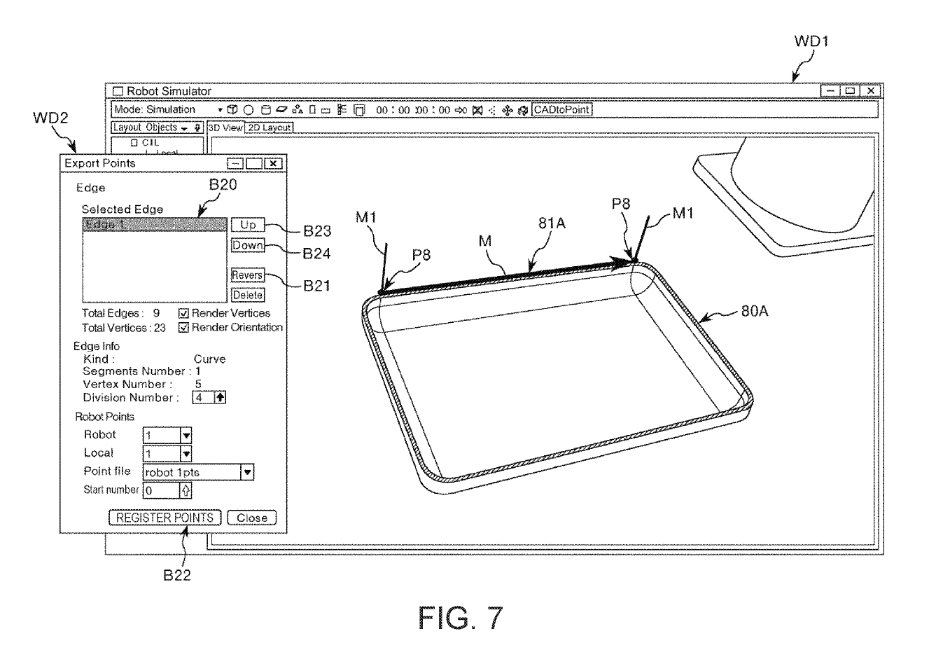

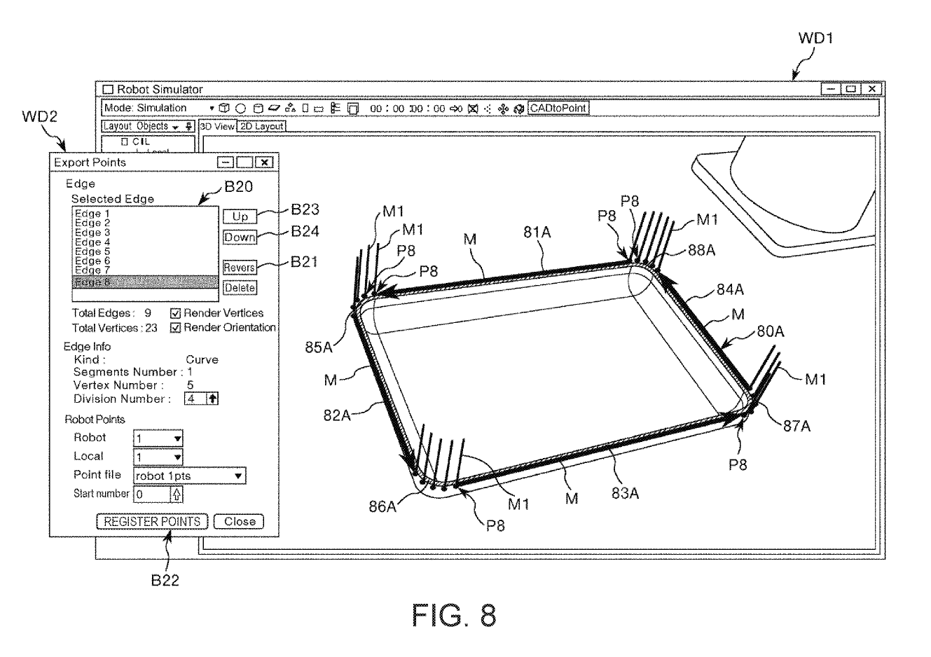

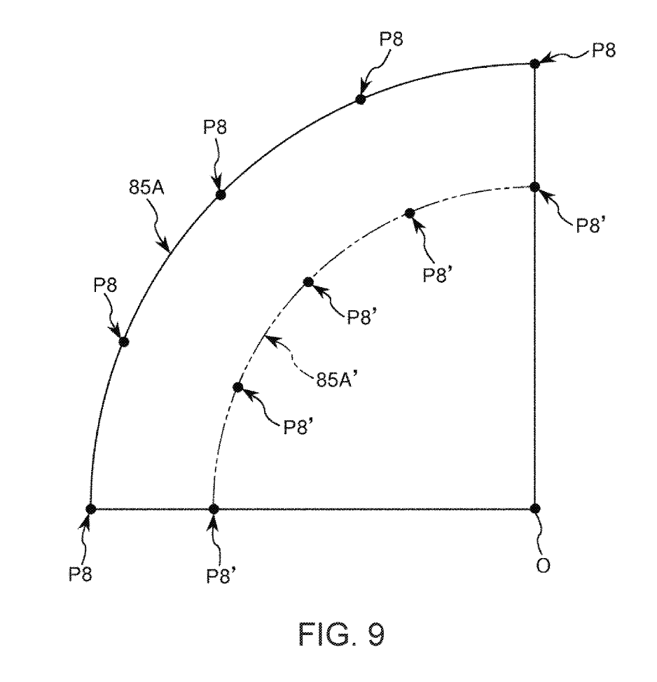

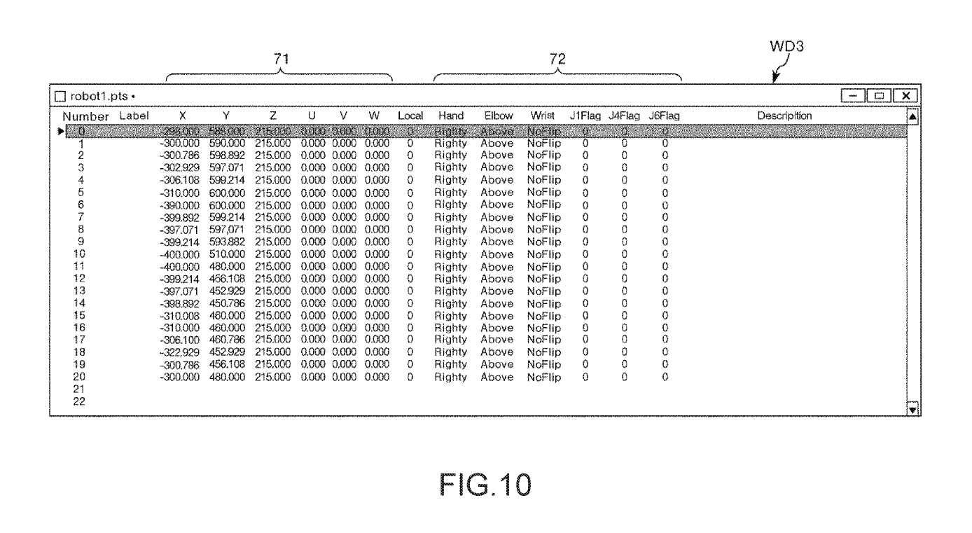

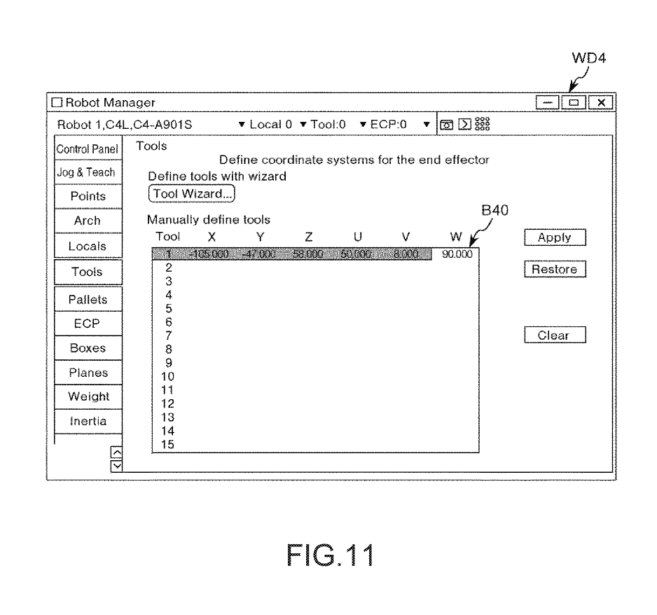

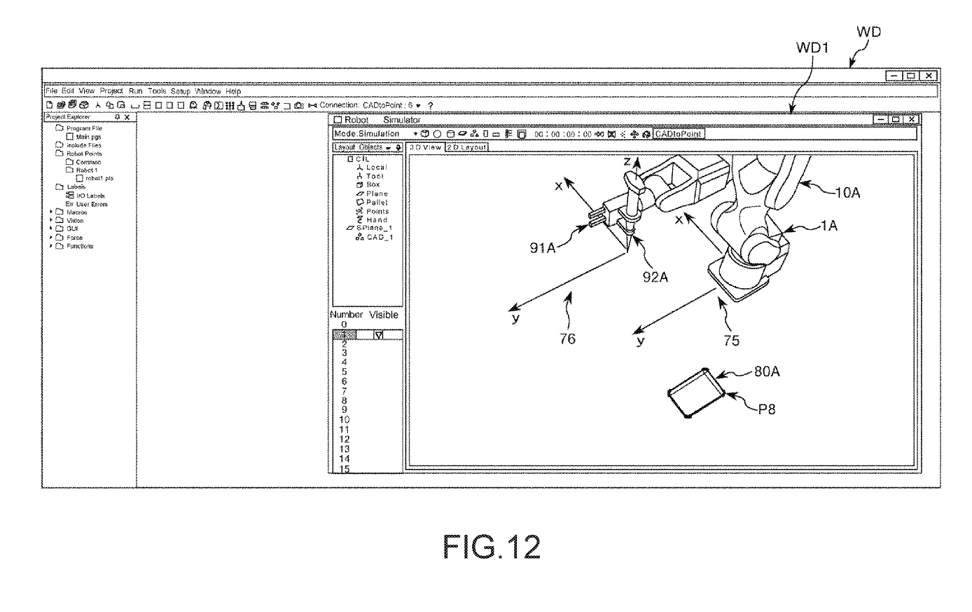

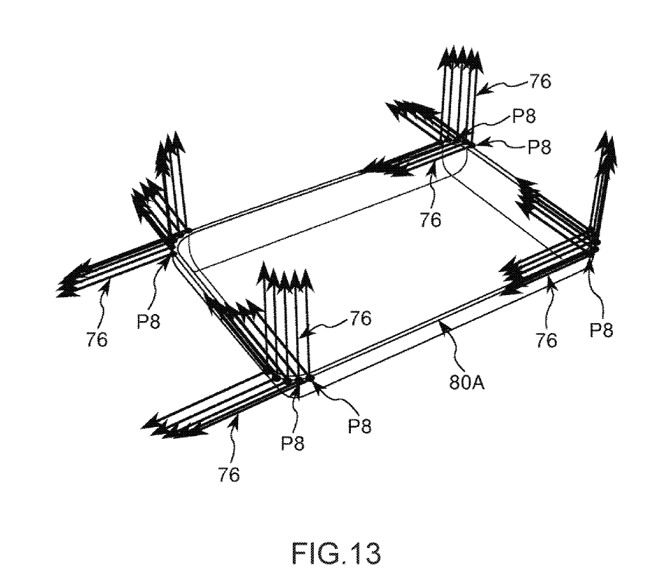

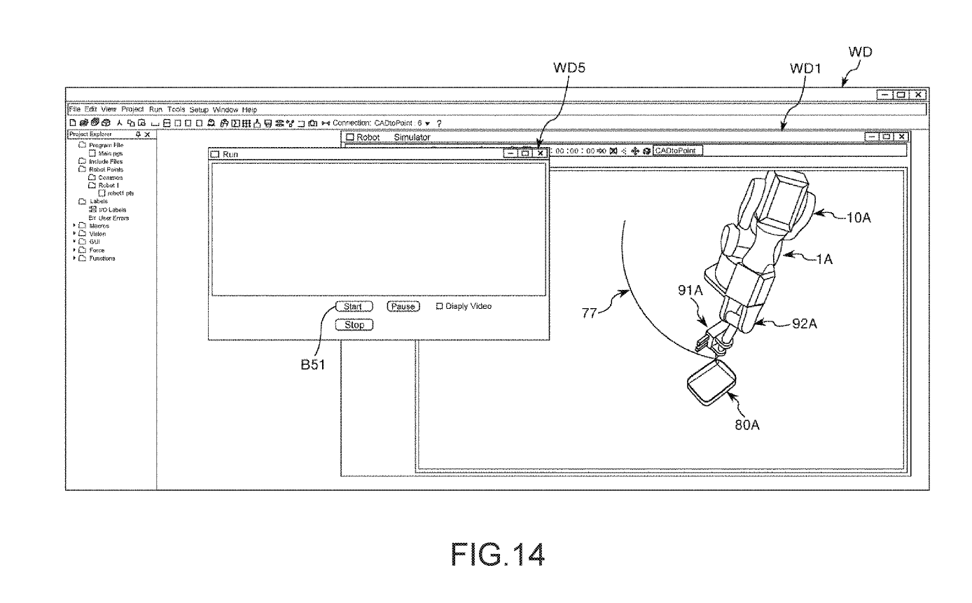

FIG. 5 is a flowchart showing a flow of setting of virtual offline teaching. FIG. 6 is a diagram for explanation of the virtual object. FIG. 7 shows a window used for storing line segments. FIG. 8 shows a window used for storing line segments. FIG. 9 is a diagram for explanation of correction of a set route. FIG. 10 shows a window of a point file. FIG. 11 shows a window used for correction of points. FIG. 12 shows a window used for proceeding with work while checking a position and an attitude of a tool and a teaching point. FIG. 13 shows an example of display of coordinate systems of a virtual applicator at the teaching points. FIG. 14 shows a window used for execution of the robot operation program.

Note that, as shown in FIG. 4, the virtual robot 1A corresponds to the above described robot 1 as the real machine. Specifically, the virtual robot 1A has a virtual base 110A, a virtual robot arm 10A (virtual manipulator), a virtual hand 91A (virtual tool), and a virtual applicator 92A (virtual attachment member). The signs of the respective parts of the virtual robot 1A are shown with “A” after the signs of the respective corresponding parts of the real robot 1. The names of the respective parts of the virtual robot 1A are shown with “virtual” before the names of the respective corresponding parts of the real robot 1. The same applies to the virtual object 80A.

As below, referring to FIG. 5, teaching of work of applying an adhesive to the virtual object 80A by the virtual robot 1A will be explained as an example. The setting of teaching and the taught work are performed according to instructions by the worker using a GUI (graphical user interface) displayed on the screen 610.

First, the processing unit 502 loads the robot simulator program file 531 and the first format CAD data file 532 (FIG. 5: step S11) saved in the file device 53, and displays (outputs) the respective three-dimensional models of the virtual robot 1A and the virtual object 80A on the screen 610. The loading is performed in response to the instruction by the worker via the screen 610 using the input unit 62. Through the processing, windows WD, WD1 as shown in FIG. 4 are displayed on the screen 610, and the respective three-dimensional models of the virtual robot 1A and the virtual object 80A are displayed in the window WD1.

Then, in response to the instruction via the screen 610 by the worker, the conversion unit 501 converts the first format CAD data file into the different second format CAD data file 534. The processing unit 502 displays the virtual object 80A based on the data of the second format CAD data file 534 on the screen 610. Thereby, as shown in FIG. 6, the virtual object 80A based on the data of the second format CAD data is displayed in the window WD1. Further, in response to the instruction via the screen 610 by the worker, the processing unit 502 performs processing of storing the second format CAD data file 534.

As shown in FIG. 6, the virtual object 80A has a tray form (with an opening) in a rectangular plane shape. The opening end of the virtual object 80A has four linear line segments 81A, 82A, 83A, 84A. The line segments 81A, 83A are opposed with the opening in between and the line segments 82A, 84A are opposed with the opening in between. Further, the opening end of the virtual object 80A has a line segment 85A in an arc shape (curved shape) connecting the line segment 81A and the line segment 82A, a line segment 86A in an arc shape connecting the line segment 82A and the line segment 83A, a line segment 87A in an arc shape connecting the line segment 83A and the line segment 84A, and a line segment 88A in an arc shape connecting the line segment 84A and the line segment 81A. In the embodiment, teaching of work of applying an adhesive to the opening end of the virtual object 80A by the virtual robot 1A is performed.

Then, the processing unit 502 displays a window WD2 as shown in FIG. 7, and performs processing of storing the line segments (FIG. 5: step S12). The window WD2 is displayed in response to a click (instruction) of “CAD to Point” shown in a menu bar of the window WD1 by the worker using the input unit 62 such as a mouse. Further, the line segments are stored in response to a click (instruction) of the opening end of the virtual object 80A by the worker using the input unit 62 such as a mouse.

Specifically, first, in response to the instruction by the worker, the processing unit 502 stores the line segment 81A. Further, one end and the other end of the line segment 81A are respectively stored as teaching points P8. In this regard, as shown in FIG. 7, the processing unit 502 displays a linear pointer M on the line segment 81A selected by the worker showing that the line segment has been selected, and displays pointers Ml respectively at the two teaching points P8. Further, the processing unit 502 displays the window WD2 and displays a number “Edge 1” showing the selected line segment 81A in a box B20 of “Selected Edge” within the window WD2. The same applies to the line segments 82A to 88A. Note that, regarding the line segments 85A to 88A in the arc shapes, five teaching points P8 are respectively stored.

For example, the worker selects all of the line segments 81A to 88A to make a circuit from the line segment 81A through the line segment 85A to the line segment 88A, that is, to make a circuit counterclockwise unicursally on the opening end of the virtual object 80A. In response to the selection, the processing unit 502 stores all line segments 81A to 88A and, as shown in FIG. 8, displays the plurality of teaching points P8 and the plurality of pointers M, Ml in the window WD1. Further, the processing unit 502 sequentially displays numbers corresponding to the line segments 81A to 88A in the box B20 of the window WD2 according to the above described order of the selection by the worker. That is, the line segments are numbered in the order of the selection. Therefore, in the embodiment, the line segment 81A corresponds to the number “Edge 1”, the segment 85A corresponds to a number “Edge 2”, the segment 82A corresponds to a number “Edge 3”, the segment 86A corresponds to a number “Edge 4”, the segment 83A corresponds to a number “Edge 5”, the segment 87A corresponds to a number “Edge 6”, the segment 84A corresponds to a number “Edge 7”, and the segment 88A corresponds to a number “Edge 8”. Note that the processing unit 502 generates and outputs a point file in the order of the arrangement in the box B20 in processing of generating and outputting a point file (step S15), which will be described later.

Then, the processing unit 502 sets the order of the line segments 81A to 88A and orientations of the respective line segments 81A to 88A (FIG. 5: step S13). This is performed in response to an instruction via the window WD2 by the worker. The worker may set the order of the line segments 81A to 88A using an “Up” button B23 and a “Down” button B24 in the window WD2. Further, the worker may set the orientations of the respective line segments 81A to 88A using a “Revers” button B21 in the window WD2. Note that, in the embodiment, the case where the worker selects all of the line segments 81A to 88A, and then, make settings of the order and the orientations is explained, however, the worker may set the order and the orientations at each time to select the respective line segments 81A to 88A.

In this manner, a set route of an operation of the virtual robot 1A based on the line segments 81A to 88A, in the embodiment, a set route of an operation of the distal end of the virtual robot arm 10A is generated.

Then, the processing unit 502 corrects the set route (FIG. 5: step S14). In the correction, at least one of contraction and expansion of the set route is performed. For example, as shown in FIG. 9, when the line segment 85A in the arc shape contains an arc, the center O of the arc of the line segment 85A is not changed, but the radius thereof is reduced. Thereby, an arc of a line segment 85A′ formed with the contracted arc of the line segment 85A is produced. That is, the line segment 85A is corrected to the line segment 85A′. By the correction, the five teaching points P8 based on the line segment 85A are corrected to five teaching points P8′ based on the line segment 85A′.

Note that, in the case of expansion, the radius of the arc may be increased. Further, the same processing as the above described processing for the line segment 85A may be performed on the line segments 86A to 88A.

With the above described correction, the positions of the line segments respectively connecting to both ends of the corrected arc are changed to follow the expansion or contraction of the arc. For example, the line segment 85A is expanded, the positions of the line segments 81A, 82A are corrected with the expansion.

As below, for convenience of explanation, the line segment 85A′ and the teaching points P8′ will be explained and shown as the the line segment 85A and the teaching points P8, respectively.

Further, in the embodiment, the correction of the set route (step S14) is performed after the setting of the orientations and the order (step S13), however, for example, the correction of the set route may be performed after output of the point file (step S15), which will be described later. In this case, the correction of the set route is performed, and then, overwriting of the point file is performed.

Then, the processing unit 502 generates and outputs the point file (FIG. 5: step S15). This is performed in response to a click (instruction) of a button B22 of “Register Points” in the window WD2 shown in FIG. 7 by the worker using the input unit 62 such as a mouse. Thereby, a window WD3 of the point file as shown in FIG. 10 is displayed. In the window WD3, a group 71 showing positions and attitudes (coordinate systems) in the distal end of the virtual robot arm 10A (specifically, a tool center point) at the respective teaching points P8 and a group 72 showing positions and attitudes of the virtual robot arm 10A are displayed. More specifically, position data (X,Y,Z) of the respective points, attitude data (U,V,W) represented by rolls (rotations about the Z-axis), pitches (rotations about the Y-axis), and yaws (rotations about the X-axis), local coordinate systems, attitudes (Hand, Elbow, and Wrist) of the virtual robot arm 10A, and flags of Joint 1, Joint 4, and Joint 6 (J1Flag, J4Flag, J6Flag) are displayed. Further, a “Number” column in the window WD3 shows the respective teaching points P8.

Here, from a normal vector, a u vector, a v vector of the curved surface containing the points (note that the u, v vectors are unit vectors forming a plane), the respective values of U, V, W are automatically calculated and output to the point file. Further, when a curved line contains the points, the respective values of U, V, W are automatically calculated from a tangent vector and a curvature vector and output to the point file. These respective values of U, V, W may be automatically calculated from a normal line and a tangent line of the points (vertexes) of the CAD data. Or, the respective values of U, V, W may be the attitude (U,V,W) of the virtual robot 1A before the start of vertical offline teaching. Whether the values calculated from the points of the CAD data are used or the attitude of the virtual robot 1A before the start of vertical offline teaching is used may be switched using a switch provided in the window WD1 or the like, for example.

When the point file is generated and output, one of the overlapping points between the connecting line segments is removed. As a criterion for determining overlapping, in comparison between the position data (X,Y,Z) and the attitude data (U,V,W) of the overlapping two points, if the acceptable error is equal to or less than a predetermined value (e.g. 0.001 mm), the points are regarded to be overlapping.

Then, the processing unit 502 enables the points (FIG. 5: step S16).

Then, the processing unit 502 performs point settings in the attachment member (FIG. 5 step S17). Here, the respective values output to the point file show coordinate systems in the distal end of the virtual robot arm 10A (more specifically, the tool center point) or the like. Accordingly, in the processing, point settings in a predetermined location (in the embodiment, the distal end) of the virtual applicator 92A as the attachment member are performed based on the above described point file. In other words, the processing unit 502 changes the set route at the distal end of the virtual robot arm 10A to a set location at the distal end of the virtual applicator 92A based on the respective values output to the above described point file.

The worker inputs desired values in an “X” column, “Y” column, “Z” column, “U” column, “V” column, and “W” column of a box B40 of “Manually define tools” of a window WD4 as shown in FIG. 11. The numerical values input in the “X” column, “Y” column, “Z” column, “U” column, “V” column, and “W” column of the box B40 are values to be added to the respective numerical values shown in the “X” column, “Y” column, “Z” column, “U” column, “V” column, and “W” column of the point file shown in FIG. 10. That is, the numerical values in the corresponding “X” column, “Y” column, “Z” column, “U” column, “V” column, and “W” column of the point file are corrected for the numerical values input to the box B40. In response to the input into the box B40 by the worker, the processing unit 502 performs point settings of the tool. Thereby, in the predetermined location (in the embodiment, the distal end) of the virtual applicator 92A, an operation of tracing the surface of the virtual object 80A is set. Note that, in place of the processing, processing of directly editing the above described point file or copying and pasting the data of the point file to e.g. a spreadsheet and editing the data and returning the edited data to the point file again may be performed. Also, in this manner, the operation of tracing the surface of the virtual object 80A is set in the predetermined location of the virtual applicator 92A.

Through the above described processing, the robot operation program is generated.

Here, in response to an instruction by the worker, as shown in FIG. 12, for example, the processing unit 502 displays a coordinate system 76 indicating the position and attitude of the virtual applicator 92A and displays a base coordinate system 75 of the virtual robot 1A in the window WD1. Further, the unit displays the respective teaching points P8 in the virtual object 80A. Furthermore, as shown in FIG. 13, the processing unit 502 may display the coordinate systems 76 of the virtual applicator 92A at the respective teaching points P8 in addition to display of the respective teaching points P8.

Then, the execution unit 503 executes (outputs) the robot operation program (FIG. 5: step S18). The worker clicks (gives an instruction by) a button B51 of “start” in a window WD5 as shown in FIG. 14 using the input unit 62 such as a mouse. In response to the instruction by the worker, the execution unit 503 outputs (executes) the robot operation program, and thereby, virtual offline teaching may be executed. In the execution of the virtual offline teaching, the processing unit 502 may display a trajectory 77 of the virtual applicator 92A along the set route.

In the above described manner, settings and execution of the virtual offline teaching may be performed.

As above, an example of the settings and execution of the virtual offline teaching by the simulation apparatus 5 is explained.

As described above, the simulation apparatus 5 as the example of the simulation apparatus according to the invention is an apparatus that performs the operation of the virtual robot 1A as the virtualization of the robot 1, and the data of the virtual object 80A is converted from the first format into the second format having the data volume compressed to one tenth or less of that of the first format. Further, the simulation apparatus 5 has the processing unit 502 that specifies the plurality of line segments of the outer shape (plurality of line segments forming the outer shape) of the virtual object 80A. The processing unit 502 operates the virtual robot 1A based on the selected line segments 81A to 88A of the plurality of line segments. According to the simulation apparatus 5, the times to read in and read out the data of the virtual object 80A or the like may be significantly reduced. Further, the work of manually deleting unnecessary data may be saved. The simulation apparatus 5 has the function of importing the three-dimensional CAD data of the virtual object 80A etc. contained in the first format CAD data file 532. The apparatus may convert the imported first format CAD data file 532 into the three-dimensional CAD data of the virtual object 80A etc. contained in the second format CAD data file 534. Furthermore, the apparatus has the function of selecting the contour forming the outer shape of the virtual object 80A based on the converted second format CAD data and generating the respective points and the coordinate systems etc. at the respective points, and generating the set route. Accordingly, as in the embodiment, the plurality of teaching points P8 and the set route of the virtual robot 1A may be generated based on the information of the line segments 81A to 88A, and the generation work may be performed relatively easily. Further, preparation of other CAD software, CAD/CAM software, or the like may be saved. Furthermore, the work is efficient because it is unnecessary to manually describe the respective points in the program. Moreover, the operation program of the virtual robot 1A using the teaching points P8 generated in the above described procedure may be created, and thereby, the man-hours for the description work of programs in combination of many teaching points P8 and the operation commands of the virtual robot 1A may be significantly reduced. Thus, the work efficiency by the simulation apparatus 5 may be improved.

Further, as described above, the processing unit 502 has the function of setting the positions and attitudes of the virtual robot 1A at the teaching points P8 on the selected respective line segments 81A to 88A. In the embodiment, the unit sets the positions and attitudes of the virtual applicator 92A when the distal end of the virtual applicator 92A is located at the teaching points P8 based on the line segments 81A to 88A (the positions and attitudes of the virtual applicator 92A based on the positions and attitudes of the virtual robot 1A). Furthermore, the unit has the function of outputting signals for indicating the set positions and attitudes of the virtual robot 1A (in the embodiment, the positions and attitudes of the virtual applicator 92A). Thereby, the unit may allow the screen 610 of the display unit 61 to display the positions and attitudes of the virtual robot 1A (in the embodiment, the positions and attitudes of the virtual applicator 92A) via the display control unit 54. In the embodiment, as shown in FIG. 13, the position and attitude of the virtual applicator 92A may be indicated by the coordinate systems 76. Thereby, the worker may visually recognize the positions and attitudes of the virtual applicator 92A of the virtual robot 1A at the respective teaching points P8 via the display unit 61. Therefore, whether with or without interferences between the virtual robot 1A and peripherals or the like during work of the virtual robot 1A may be easily considered.

In the simulation apparatus according to the invention, the attitude of the virtual robot 1A (in the embodiment, the attitude of the virtual applicator 92A) at the teaching point P8 can be changed. Further, the position of the virtual robot 1A (in the embodiment, the position of the virtual applicator 92A) at the teaching point P8 can be changed. Specifically, as described above, the change may be made in response to the instruction by the worker using the window WD4 shown in FIG. 11. Thereby, the optimal position and attitude of the virtual robot 1A during work may be set according to whether with or without interferences between the virtual robot LA and peripherals or the like. Further, the position and attitude of the virtual applicator 92A may be easily changed using the window WD4 in the virtual space (on the screen 610), and thus, offline teaching may be performed only by forward kinematics without inverse kinematics computation. Thus, it is necessary to obtain all (plurality of) solutions, and load may be reduced and the processing time may be shortened. Furthermore, the position and attitude of the virtual applicator 92A may be easily changed, and thereby, the apparatus is effective because various positions and attitudes of the virtual robot 1A during work may be easily considered before offline teaching of the robot 1 as the real machine.

In the simulation apparatus 5, the set route of the operation of the virtual robot 1A can be generated based on the selected line segments 81A to 88A, and the position of the generated set path can be changed. Specifically, as described above, the simulation apparatus 5 may change the set route in the distal end of the virtual robot arm 10A (a predetermined location of the virtual robot) to a set route in the distal end of the virtual applicator 92A (a predetermined location of a virtual tool or virtual attachment member) in response to the instruction by the work using the window WD4 shown in FIG. 11. Thereby, optimal set routes according to details of work, types of tools or attachment members, etc. may be generated.

Further, in the simulation apparatus 5, the set route of the operation of the virtual robot 1A can be generated based on the selected line segments 81A to 88A, and at least one of contraction and expansion of the generated set route can be performed. Particularly, when the generated set route contains the line segments 85A to 88A forming arcs, at least one of contraction and expansion of the set route can be performed by changing the radius of the arc without changing the center of the arc. Thereby, the set route containing the arc-shaped (curved) line segments 85A to 88A may be easily set and changed according to the details of work.

As above, the simulation apparatus, the robot control apparatus, and the robot according to the invention are explained based on the illustrated embodiment, however, the invention is not limited to those. For example, the configurations of the respective parts of the above described embodiment may be replaced by arbitrary configurations having the same functions or other arbitrary configurations may be added thereto.

In the above described embodiment, the six-axis vertical articulated robot is explained as an example of the robot, however, the robot includes, but not limited to, another type of robot e.g. a horizontal articulated robot.

In the above described embodiment, the first format CAD data file containing the data of the virtual object is explained as an example, however, the first format CAD data file may contain data of a virtual peripheral as a virtualization of a peripheral or the like in addition to the data of the virtual object.

Further, in the above described embodiment, the first format CAD data file is loaded, and then, converted into the second format data file having the lower data volume, however, may be converted into the second format data file before loading.

In the simulation (including the virtual offline teaching) of the virtual robot in the above described embodiment, the case where the application work of the adhesive to the object is explained as an example, however, for example, a simulation of work along the shape of an object such as an object of polishing work or welding work may be performed.

The entire disclosure of Japanese Patent Application No. 2016-153944, filed Aug. 4, 2016 is expressly incorporated by reference herein.

What is claimed is:

1. A simulation apparatus that performs an operation of a virtual robot as a virtualization of a robot, comprising a processor that is configured to specify a plurality of line segments of an outer shape of a virtual object as a virtualization of a work object of the robot,
wherein data of the virtual object is converted from a first format into a second format having a data volume compressed to one tenth or less of that of the first format, and
the processor configured to operate the virtual robot based on selected line segments of the plurality of line segments.

2. The simulation apparatus according to claim 1, wherein the second format has one hundredth data volume or less of that of the first format.

3. The simulation apparatus according to claim 1, wherein the second format is an XVL format.

4. The simulation apparatus according to claim 1, wherein the processor is configured to have a function of setting a position and an attitude of the virtual robot at teaching points on the selected respective line segments and a function of outputting signals for indicating the set position and attitude of the virtual robot.

5. The simulation apparatus according to claim 4, wherein the setting of the attitude of the virtual robot at the teaching point can be changed.

6. The simulation apparatus according to claim 4, wherein the setting of the position of the virtual robot at the teaching point can be changed.

7. The simulation apparatus according to claim 1, wherein a set route of an operation of the virtual robot based on the selected line segments can be generated and a position of the generated set route can be changed.

8. The simulation apparatus according to claim 1, wherein a set route of an operation of the virtual robot based on the selected line segments can be generated and at least one of contraction and expansion of the generated set route can be performed.

9. The simulation apparatus according to claim 1, wherein, when the set route contains an arc, at least one of contraction and expansion of the set route can be performed by changing a radius of the arc without changing a center of the arc.

10. A robot control apparatus controlling a robot based on a simulation result by the simulation apparatus according to claim 1.

11. A robot control apparatus controlling a robot based on a simulation result by the simulation apparatus according to claim 2.

12. A robot control apparatus controlling a robot based on a simulation result by the simulation apparatus according to claim 3.

13. A robot control apparatus controlling a robot based on a simulation result by the simulation apparatus according to claim 4.

14. A robot control apparatus controlling a robot based on a simulation result by the simulation apparatus according to claim 5.

15. A robot control apparatus controlling a robot based on a simulation result by the simulation apparatus according to claim 6.

16. A robot controlled by the robot control apparatus according to claim 10.

17. A robot controlled by the robot control apparatus according to claim 11.

18. A robot controlled by the robot control apparatus according to claim 12.

19. A robot controlled by the robot control apparatus according to claim 13.

20. A robot controlled by the robot control apparatus according to claim 14.
